(19) United States
(12) Patent Application Publication
(10) Pub. No.: US 2015/0015830 A1
(43) Pub. Date: Jan. 15, 2015

(54) LIQUID CRYSTAL PANEL AND LIQUID CRYSTAL DISPLAY DEVICE INCLUDING THE SAME

(71) Applicant: DONGWOO FINE-CHEM CO., LTD., Jeollabuk-do (KR)

(72) Inventors: Sung Su KIM, Gyeonggi-do (KR); Je Hoon SONG, Gyeonggi-do (KR)

(21) Appl. No.: 14/323,850

(22) Filed: Jul. 3, 2014

(30) Foreign Application Priority Data
Jul. 11, 2013 (KR) 10-2013-0081556

(51) Int. Cl. G02F 1/1335

(52) U.S. Cl. CPC G02F 1/133528
USPC 349/96

(57) ABSTRACT

A liquid crystal panel includes an upper polarizing plate and a lower polarizing plate whose absorption axes are disposed to be parallel to each other, a liquid crystal cell disposed between the upper polarizing plate and the lower polarizing plate, and a polarization rotating layer which is disposed between the upper polarizing plate and the lower polarizing plate to rotate linearly polarized light by 85° to 95°, and has reverse wavelength dispersion characteristics, thereby preventing deflection of the liquid crystal panel and improving visibility properties.

### CROSS REFERENCE TO RELATED APPLICATIONS

This application claims priority from Korean Patent Application No. 10-2013-0081556, filed on Jul. 11, 2013 in the Korean Intellectual Property Office, the entire disclosure of which is incorporated herein by reference.

### BACKGROUND

1. Field of the Invention

The present invention relates to a liquid crystal panel and a liquid crystal display device including the same, and more specifically, to a liquid crystal panel with improved visibility properties and a liquid crystal display device including the same.

2. Description of the Related Art

Liquid crystal display devices (LCDs) include a liquid crystal panel in which an upper polarizing plate and a lower polarizing plate are adhered to a visible side and a backlight unit side of a liquid crystal cell, respectively, as shown in FIG. 1.

A conventional polarizing plate, which is adhered to the liquid crystal cell by an adhesive layer, includes a polyvinylalcohol (PVA) polarizer, and protective films laminated on at least one side of the polarizer. At this time, the polarizing plates including the upper polarizing plate and the lower polarizing plate are adhered on both sides of the liquid crystal cell.

Conventionally, polarizers in the upper polarizing plate and the lower polarizing plate are disposed in a cross-nicol state. For example, in the case of a liquid crystal panel having a normally black mode such as a vertical alignment (VA) mode or in-plane switching (IPS) mode, an absorption axis direction of the polarizer in the upper polarizing plate and an absorption axis direction of the polarizer in the lower polarizing plate are orthogonal to each another.

According to recent trends in upsizing of display devices, the width of a film disc is limited during preparation of the polarizer, therefore, it is difficult to manufacture a large polarizer having a perpendicular absorption axis.

In addition, optical films disposed on both sides of the liquid crystal cell are shrunk or expanded by changes in temperature or humidity at the time of using the liquid crystal panel. When the optical films are shrunk or expanded, the liquid crystal cell to which these films are adhered may be deflected, thereby resulting problems such as light leakage or the like.

With respect to these problems, Japanese Patent Laid-Open Publication No. 2002-207211 discloses a liquid crystal display device which includes a polarizing plate having transparent protective layers on both sides of a polyvinyl alcohol-based polarizing film, wherein the thickness of the polarizing plate on a viewer's side and the thickness of the polarizing plate on the rear side are satisfy a predetermined relation, thereby preventing a deflection of the liquid crystal panel.

Further, Korean Patent Laid-Open Publication No. 2003-0087893 discloses a liquid crystal panel which includes a polarizing plate containing adhesives for adhering to a liquid crystal cell, wherein the adhesives have different adhesion strengths to provide the same contractive force thereto, and Korean Patent Laid-Open Publication No. 2005-0080504 discloses a liquid crystal panel including an upper polarizing plate and a low polarizing plate which are respectively adhered to both sides of a liquid crystal cell by adhesive layers having different contractive strengths.

Further, according to recent upsizing of the liquid crystal panels, a deflection problem with the liquid crystal panel due to expansion and contraction of the optical film (e.g., the polarizing plate) becomes more important, and has not yet been fully resolved.

### SUMMARY

Accordingly, provided is a liquid crystal display device with reduced light leakage via preventing a deflection of the liquid crystal panel.

In addition, provided is a liquid crystal display device with excellent visibility properties via improving the contrast ratio in a front side and slope.

Embodiments of the present invention may include the following characteristics:

A liquid crystal panel having: an upper polarizing plate and a lower polarizing plate whose absorption axes are disposed to be parallel to each other; a liquid crystal cell disposed between the upper polarizing plate and the lower polarizing plate; and a polarization rotating layer which is disposed between the upper polarizing plate and the lower polarizing plate to rotate linearly polarized light by 85° to 95°, and has reverse wavelength dispersion characteristics.

The liquid crystal panel may further include the polarization rotating layer having wavelength dispersion characteristics of Ro (450)/Ro (550)=0.75 to 0.95 and Ro (650)/Ro (550)=1.0 to 1.1.

Further, the liquid crystal panel as above, wherein the polarization rotating layer includes a single half (½) wave plate layer or a plurality of half (½) wave plate layers. Further still, the liquid crystal panel as above, wherein the polarization rotating layer includes three half (½) wave plate layers, and each of the half wave plates has an angle between an optical axis thereof and the absorption axis of the polarizing plate in a range of 6° to 16°, 40° to 50°, and 74° to 84°.

The liquid crystal panel as above may also include the polarization rotating layer wherein the polarization rotating layer includes three half (½) wave plate layers, and each of the half wave plates has an angle between an optical axis thereof and the absorption axis of the polarizing plate in a range of 8° to 14°, 42° to 48°, and 76° to 82°.

Further, the liquid crystal panel according as above, wherein the polarization rotating layer includes three half (½) wave plate layers, and each of the half wave plates has an angle between an optical axis thereof and the absorption axis of the polarizing plate in a range of 17.5° to 27.5°, 40° to 50°, and −27.5° to −17.5°.

Further still, the liquid crystal panel as above, wherein the polarization rotating layer is formed in a plurality of half (½) wave plate layers, and any one of the plurality half wave plate layers has wavelength dispersion characteristics of Ro (450)/Ro (550)=1.0 to 1.1, and Ro (650)/Ro (550)=0.9 to 1.0.

The liquid crystal panel as above may also include, the polarization rotating layer wherein the polarization rotating layer is adhered to a surface of the upper polarizing plate or the lower polarizing plate facing to one side of the liquid crystal cell.

Further, the liquid crystal panel according as above, wherein the polarization rotating layer is adhered to a surface of a polarizer of the upper polarizing plate or the lower polarizing plate facing to one side of the liquid crystal cell.

Further still, liquid crystal panel as above, further including an optical compensation layer.

The liquid crystal panel as above may also include, the liquid crystal cell wherein the liquid crystal cell has a vertical alignment liquid crystal mode or a horizontal alignment liquid crystal mode.

Further, the liquid crystal panel as above, wherein, when the liquid crystal cell has a vertical alignment liquid crystal mode, and the liquid crystal cell further comprises an optical compensation layer having retardation characteristics of front retardation value in a range of Ro 40 to 90 nm, and refractive index ratio (Nz) in a range of −0.11×Ro+11.7 to −0.16×Ro+18.3.

Further still, the liquid crystal panel as above, wherein, when the liquid crystal cell has a horizontal alignment liquid crystal mode, the liquid crystal cell further comprises an optical compensation layer having retardation characteristics of front retardation value in a range of Ro 70 to 270 nm, and refractive index ratio (Nz) in a range of 0.9 to 1.3.

The liquid crystal panel as above may also include the optical compensation layer wherein the optical compensation layer is adhered to the surface of the upper polarizing plate or the lower polarizing plate facing to one side of the liquid crystal cell.

Further, the liquid crystal panel as above, wherein the optical compensation layer is adhered to the surface of the polarizer of the upper polarizing plate or the lower polarizing plate facing to one side of the liquid crystal cell.

Further still, the liquid crystal panel as above, wherein the polarization rotating layer is adhered to the surface of the polarizer of the upper polarizing plate or the lower polarizing plate facing to one side of the liquid crystal cell, and the optical compensation layer is adhered to the surface of the polarizer of the upper polarizing plate or the lower polarizing plate facing to the other side of the liquid crystal cell.

Also provided, in one embodiment is a liquid crystal display device having the liquid crystal panel according to any one of the embodiments described above.

The liquid crystal display device of the present invention also includes the upper and lower polarizing plates whose absorption axes are disposed to be parallel to each other, thus the top and lower plates may be shrunk or expanded in the same direction, and a stress may be applied to both sides of the liquid crystal cell in the same direction, thereby preventing deflection of the liquid crystal panel.

Further, the liquid crystal display device of the present invention includes a polarization rotating layer which rotates the linearly polarized light by about 90°, therefore, an image display function of the liquid crystal panel may be attained effectively.

In addition, since the liquid crystal display device of the present invention has reverse wavelength dispersion characteristics, contrast ratios in a front side and slope, as well as the visibility properties, can be improved.

Further, since the liquid crystal display device of the present invention includes an optical compensation layer having specific optical characteristics, contrast ratios in a slope can be further improved.

### BRIEF DESCRIPTION OF THE DRAWINGS

The above and other embodiments, features, and other advantages of the present invention will be more clearly understood from the following detailed description taken in conjunction with the accompanying drawings, in which:

FIG. 1 is a cross-sectional view schematically illustrating a conventional liquid crystal panel;

FIG. 2 is a cross-sectional view schematically illustrating a liquid crystal panel according to one embodiment of the present invention;

FIG. 3 is a cross-sectional view schematically illustrating a liquid crystal panel according to another embodiment of the present invention;

FIG. 4 is a cross-sectional view schematically illustrating a liquid crystal panel according to another embodiment of the present invention; and

FIG. 5 is a schematic view illustrating the relationships of the refractive indexes (nx, ny and nz) in a three-dimensional Cartesian coordinate system.

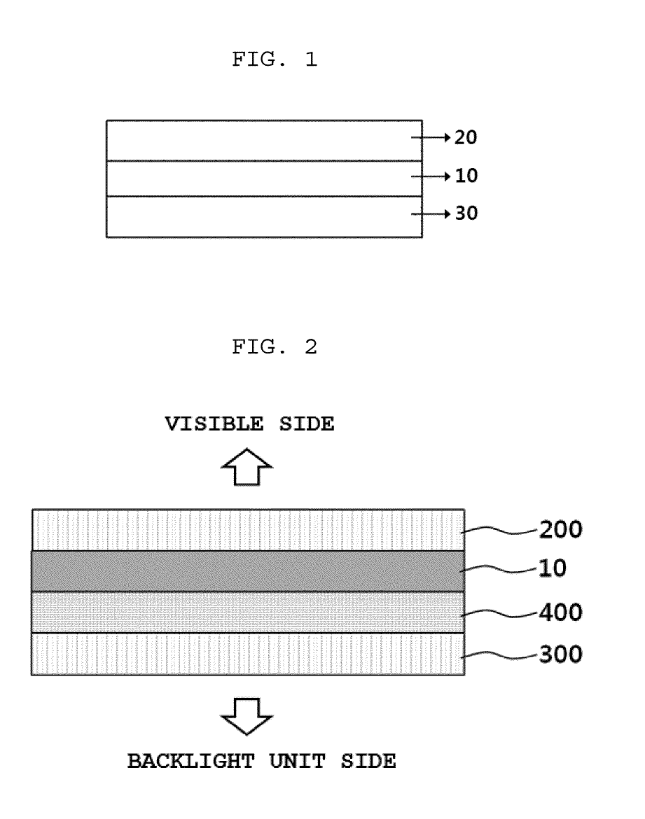

### DETAILED DESCRIPTION

The present invention discloses a liquid crystal panel including an upper and a lower polarizing plates whose absorption axes are disposed to be parallel to each other, and a polarization rotating layer which is disposed between the upper and lower polarizing plates, thereby preventing deflection of the liquid crystal panel and improving visibility properties.

Hereinafter, embodiments will be described to more concretely understand the present invention with reference to examples and comparative examples. However, those skilled in the art will appreciate that such embodiments are provided for illustrative purposes only and do not limit the subject matter to be protected as disclosed in the detailed description and appended claims. Therefore, it will be apparent to those skilled in the art that various alterations and modifications of the embodiments herein are possible within the scope and spirit of the present invention and may be duly included within the range as defined by the appended claims.

The liquid crystal panel of the present invention includes an upper polarizing plate 20 and a lower polarizing plate 30 whose absorption axes are disposed to be parallel to each other, and a liquid crystal cell 10 disposed between the upper polarizing plate and the lower polarizing plate, as well as a polarization rotating layer which is disposed between the upper polarizing plate and the lower polarizing plate to rotate linearly polarized light by 85° to 95°, and has reverse wavelength dispersion characteristics.

FIG. 2 is a cross-sectional view schematically illustrating a liquid crystal panel according to one embodiment of the present invention. The liquid crystal panel of the present invention includes a liquid crystal cell 10, an upper polarizing plate 200 and a lower polarizing plate 300 at a visible side and a backlight unit side, respectively, with reference to the liquid crystal cell 10, as well as a polarization rotating layer 400.

Polarizing Plate

The upper polarizing plate 200 and the lower polarizing plate 300 according to the present invention have polarizers, respectively, which are disposed such that their absorption axes are parallel to each other. Therefore, the upper and lower polarizers may be shrunk or expanded in the same direction, and a stress may be uniformly applied to both sides of the liquid crystal cell in the same direction, thus, deflection of the liquid crystal panel can be prevented. Further, a limited impact applied to the polarizing plate due to the width of the disc may be minimized during the manufacturing process.

The upper polarizing plate 200 and the lower polarizing plate 300 may be a single polarizing plate layer or a laminate in which a protective film is laminated on at least one surface of a polarizer.

Any conventional polarizer known in the related art may be used as the polarizer in the upper and lower polarizing plates 200 and 300, without particular limitation thereof. For example, a polarizer that includes a stretched polymer film having a dichroic dye adsorbed and oriented thereon may be used.

The types of the polymer film used to form a polarizer are not particularly limited so long as they are possibly dyed by dichroic materials such as iodine, and may include, for example, a hydrophilic polymer film such as a polyvinylalcohol film, ethylene-vinyl acetate copolymer film, ethylene-vinyl alcohol copolymer film, cellulose film and/or a partially saponified film thereof, or a polyene oriented film such as a dehydrated polyvinylalcohol film, a dehydrochlorinated polyvinyl alcohol film, or the like. Among these, the polyvinylalcohol films contain aspects related to excellent effects of reinforcing uniformity of polarities in planes and superior dyeing-affinity to dichroic materials.

A polyvinylalcohol film prepared by saponification of a polyvinyl acetate resin may also be used. Such a polyvinyl acetate resin may include polyvinyl acetate as a homopolymer of vinyl acetate, as well as a copolymer of vinyl acetate and any other monomer copolymerizable therewith. Such a monomer copolymerizable with vinyl acetate may include, for example, unsaturated carboxylic acid monomers, unsaturated sulfonic acid monomers, olefin monomers, vinyl ether monomers, ammonium group-containing acrylamide monomers, and the like.

In addition, the polyvinyl alcohol resin may include modified resin, for example, aldehyde-modified polyvinylformal, polyvinylacetal, and the like. A saponification value of the polyvinylalcohol resin generally ranges from 85 to 100 mol % and may be 98 mol % or more. Also, a polymerization degree of the polyvinyl alcohol resin generally ranges from 1,000 to 10,000 and may be 1,500 to 5,000.

The polyvinyl alcohol resin described above may be formed into a film and this film may be used as a disc film of a polarizer. Film formation using a polyvinyl alcohol resin is not particularly limited and may include any number of known methods. Also, the thickness of the disc film is not particularly limited but, for example, may range from 10 to 150 μm.

The polarizer may have the disc film fabricated by any method known in the art. For example, the disc film of the polarizer may be fabricated via a process of swelling, dyeing, cross-linking, stretching, etc., and the sequence and number of the processes are without limitation. An overall stretching ratio may range from 4.5 to 7.0 times, and may include 5.0 to 6.5 times of the original size.

The upper and lower polarizing plates 200 and 300 may include a polarizer protective film on at least one surface of the polarizer.

The protective film may include any film having favorable transparency, mechanical strength, thermal stability, moisture shielding properties, isotropic properties, or the like. In particular, the film may be prepared using thermoplastic resin including, for example: polyester resin such as polyethylene terephthalate, polyethylene isophthalate, polybutylene terephthalate, etc.; cellulose resin such as diacetyl cellulose, triacetyl cellulose, etc.; polycarbonate resin; acryl resin such as polymethyl (meth)acrylate, polyethyl (meth)acrylate, etc.; styrene resin such as polystyrene, acrylonitrile-styrene copolymer, etc.; polyolefin resin such as polyethylene, polypropylene, cyclic polyolefin or polyolefin having a norbornene structure, ethylene-propylene copolymer, etc.; vinyl chloride resin; polyimide resin such as nylon, aromatic polyimide; imide resin; polyether sulfonic resin; sulfonic resin; polyether ketone resin; polyphenylene sulfide resin; vinylalcohol resin; vinylidene chloride resin; vinylbutyral resin; allylate resin; polyoxymethylene resin; epoxy resin, and the like. Further, a film formed using a blend of at least one thermoplastic resin described above may be used. Furthermore, a film formed using thermosetting resin based on (meth)acrylate, urethane, acrylic urethane, epoxy, silicon, etc., or UV-curable resin may also be used.

The thermoplastic resin of the protective film may be included in an amount of 50 to 100 wt. %, 50 to 99 wt. %, 60 to 98 wt. %, or 70 to 97 wt. % to a total weight of the protective film. If a content of the thermoplastic resin is less than 50 wt. %, a high transparency inherently provided to the thermoplastic resin may not be sufficiently expressed.

The transparent protective film described above may include at least one suitable additive. The additive may include, for example, UV-absorbers, antioxidants, lubricants, plasticizers, releasing agents, anti-coloring agents, flame retardants, nucleating agents, antistatic agents, pigments, colorants, and the like.

Optionally, the protective film may be surface treated. Such a surface treatment may include a drying process such as plasma processing, corona treatment, primer processing, etc., or chemical treatment such as alkalization including saponification.

Polarization Rotating Layer

In the upper polarizing plate 200 and the lower polarizing plate 300 whose absorption axes are disposed to be parallel to each other, the polarization rotating layer 400 functions to rotate the linearly polarized light by about 90°. Therefore, even if the absorption axis of the polarizing plate is arranged in parallel, a normally black mode (i.e., a black mode when the liquid crystal is in the OFF state) can be attained. In the present invention, the angle of 90° refers to substantially about 90°, for example, may be 85° to 95°.

In addition, the polarization rotating layer 400 according to the present invention has reverse wavelength dispersion characteristics. When the polarization rotating layer 400 has reverse dispersion characteristics, excellent visibility properties may be attained by particularly improving the contrast ratio in a front side.

The polarization rotating layer 400 may have reverse dispersion characteristics of Ro (450)/Ro (550)=0.75 to 0.95 and Ro (650)/Ro (550)=1.0 to 1.1. If the polarization rotating layer 400 has reverse dispersion characteristics of the above range, it is possible to provide a remarkably high contrast ratio in a front side.

The polarization rotating layer 400 may be a half (½) wave plate having the above-described reverse dispersion characteristics. If the half wave plate has the reverse dispersion characteristics, the polarization rotating layer 400 may be a single half wave plate or a plurality of half wave plate layers. The plurality of half wave plate layers may be used in aspects of improving the contrast ratio in a front side. When using the plurality of half wave plate layers, for example, a half wave plate having a structure laminated in two or three layers may be used. In the case of using the plurality of half wave plate layers, if they have the reverse dispersion characteristics, the individual half wave plate may not have the reverse dispersion characteristics. For example, the individual half wave plate may have reverse dispersion characteristics, normal dispersion characteristics, or flat dispersion characteristics (Ro (450)/Ro (550)=1.0 and Ro (650)/Ro (550)=1.0), and the polarization rotating layer 400 may be formed by a combination of these dispersion characteristics. When the individual half wave plate has the normal dispersion characteristics, a half wave plate of Ro (450)/Ro (550)=1.0 to 1.1 and Ro (650)/Ro (550)=0.9 to 1.0 is used in aspects related to improvement of the contrast ratio in a front side. In order to maximize the improvement of the contrast ratio in a front side, the half wave plate may have reverse or flat dispersion characteristics.

In another embodiment, the polarization rotating layer 400 includes three half (½) wave plate layers, and each of the half wave plates have an angle between an optical axis thereof and the absorption axis of the polarizing plate in the range of 6° to 16°, 40° to 50°, and 74° to 84°, and 8° to 14°, 42° to 48°, and 76° to 82°. If the half wave plate has an angle within the above-defined ranges, excellent improvement of the contrast ratio in a front side may be achieved.

In another embodiment, the polarization rotating layer 400 includes three half (½) wave plate layers, and each of the half wave plates have an angle between an optical axis thereof and the absorption axis of the polarizing plate in a range of 17.5° to 27.5°, 40° to 50°, and −27.5° to −17.5°. If the half wave plate has an angle within the above-defined ranges, continuous production is possible via a roll-to-roll process (e.g., oblique stretching). When the half wave plate has an angle out of the above-described range, it is necessary to cut the prepared half wave plate film, and then align the position thereof so as to meet the angle to be laminated, hence lowering the productivity.

When the polarization rotating layer 400 has the structure and optical characteristics as described above, the contrast ratio in a front side may be remarkably improved.

The half wave plate may be made of any conventional material known in the related art, without particular limitation thereof. For example, polyolefin (e.g., polyethylene, polypropylene, polynorbornene, etc.), amorphous polyolefin, polyimide, polyamidimide, polyamide, polyether imide, polyether ether ketone, polyether ketone, polyketone sulfide, polyether sulfone, polysulfone, polyphenylene sulfide, polyphenylene oxide, polyethylene terephthalate, polybutylene terephthalate, polyethylene naphthalate, polyacetal, polycarbonate, polyarylate, polymethyl methacrylate, polymethacrylate, poly acrylate, polystyrene, cellulose-based polymer (e.g., triacetyl cellulose), PVA, epoxy resin, phenol resin, norbornene resin, polyester resin, acrylic resin, vinyl chloride resin, vinylidene chloride resin, and the like may be used alone or in any combination of at least two or more thereof.

The half wave plate may be manufactured by: forming a layer using these resin compositions; and mono-axially drawing or bi-axially drawing the prepared layer. Further, an alignment film with a liquid crystalline copolymer or liquid crystalline monomer oriented may be used as the half wave plate.

The polarization rotating layer 400 may be disposed at any position, if light transmitted through the lower polarizing plate 300 can transmit the polarization rotating layer 400 before incident into the upper polarizing plate 200, without particular limitation thereof.

For example, as shown in FIG. 2, the polarization rotating layer 400 may be adhered to a surface of the upper polarizing plate 200 or the lower polarizing plate 300 facing to one side of the liquid crystal cell 10. FIG. 2 illustrates an example in which the polarization rotating layer 400 is adhered to the surface of the lower polarizing plate 300 facing to one side of the liquid crystal cell 10. Each of the upper and lower polarizing plates 200 and 300 may include a polarizer and protective films adhered to both ends thereof. In this case, the polarization rotating layer 400 may be adhered to any one surface of the protective film of the polarizer facing to one side of the liquid crystal cell 10.

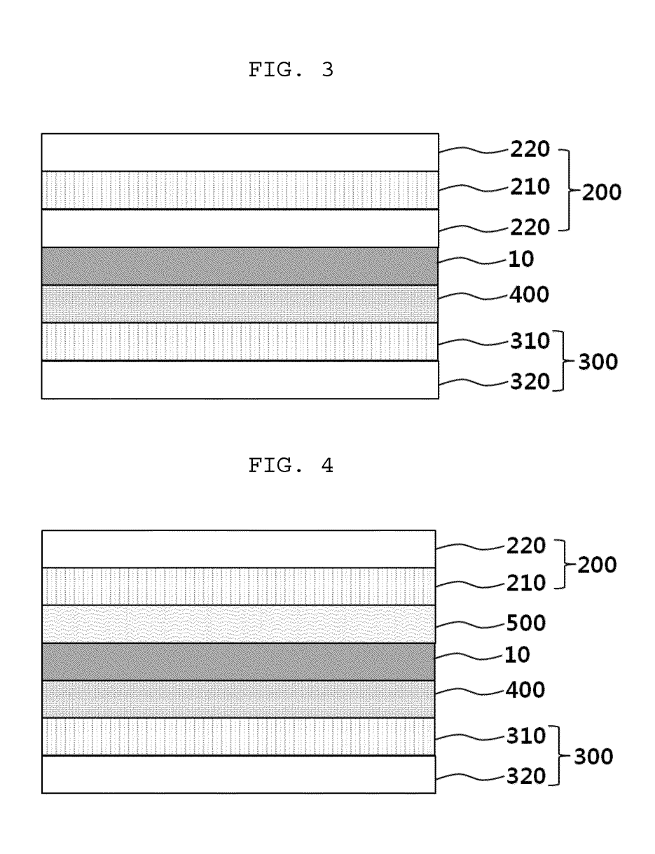

Alternately, the polarization rotating layer 400 may be formed, instead of the protective film at the liquid crystal cell 10 on a side of the upper or lower polarizing plate 200 or 300. That is, the polarization rotating layer 400 may be adhered to a side of the liquid crystal cell 10 on a polarizer in the upper or lower polarizing plate 200 or 300. FIG. 3 illustrates the polarization rotating layer 400 which is directly adhered to a side of the liquid crystal cell 10 on the polarizer 310 in the lower polarizing plate 300. When the polarization rotating layer 400 is formed at a position of the protective film, a thin film structure may be attained by eliminating the protective film.

Liquid Crystal Cell

Any structure of the liquid crystal cell 10 may be used without particular limitation thereof. For example, the liquid crystal cell may include a pair of liquid crystal cell substrates, a spacer interposed between the pair of liquid crystal cell substrates, a liquid crystal layer which is formed between the pair of liquid crystal cell substrates and has a liquid crystal material injected therein, a color filter disposed on an inner surface of the liquid crystal cell substrate at a visible side, and an electrode element such as a TFT substrate for driving disposed on an inner surface of the liquid crystal cell substrate at the other side.

The liquid crystal material to be injected into the liquid crystal layer is not particularly limited, and any proper material may be used according to the liquid crystal mode. The liquid crystal mode may be used, for example, a normally black mode such as a vertical alignment liquid crystal mode including a vertical alignment (VA), or a horizontal alignment liquid crystal mode including in-plane switching (IPS) or fringe field switching (FFS). Among these, the liquid crystal cell in VA mode may be used due to attaining a very high contrast ratio.

Optical Compensation Layer

The liquid crystal panel of the present invention may further include an optical compensation layer.

According to the present invention, the liquid crystal panel may further include an optical compensation layer, in order to improve the contrast ratio in a slope. FIG. 4 illustrates an embodiment of the liquid crystal panel according to the present invention having an optical compensation layer 500.

In one embodiment, when the liquid crystal cell 10 is in the VA mode, the optical compensation layer 500 has a front retardation value in the range of Ro 40 to 90 nm, and a refractive index ratio (Nz) in the range of −0.11×Ro+11.7 to −0.16×Ro+18.3. Within the above range, a remarkably high contrast ratio in a slope may be attained.

In the present invention, the front retardation value Ro is an actual retardation value obtained when a light passes through the optical compensation layer in a normal direction (i.e., a vertical direction) of the film, and is defined by the following Equation 1.

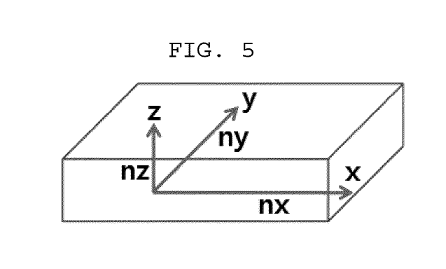

Rₒ=(nx−ny)×d [Equation 1]

Wherein nx and ny represent an in-plane refractive index of the film, and in particular, when the vibration direction in which the in-plane refractive index is maximum sets x, a refractive index by the light vibrating in this direction is nx, nx and ny are perpendicular to each other, and nx≧ny; and d represents a thickness of the film. Meanwhile, the refractive index of the film includes nz, and nz represents a refractive index in a direction perpendicular to the plane defined by nx and ny (i.e., a thickness direction of the film). FIG. 5 schematically illustrates the directional relationships between the nx, ny and nz.

Commonly, the refractive index ratio Nz is defined by the following Equation 2.

$$Nz = \frac{( nx - nz )}{( nx - ny )} \qquad [ Equation 2 ]$$

When the optical compensation layer applied to the liquid crystal cell of the present invention has the refractive index ratio within the above-defined range, it is possible to provide a high contrast ratio in a slope.

In another embodiment, when the liquid crystal cell 10 is in the IPS mode, the optical compensation layer 500 has a retardation value in the range of Ro 70 to 270 nm, and a refractive index ratio (Nz) in the range of 0.9 to 1.3. When the optical compensation layer has the retardation characteristics within the above ranges, a remarkably high contrast ratio in a slope may be attained.

The arrangement position of the optical compensation layer 500 is not particularly limited. For example, the optical compensation layer 500 may be adhered to any one surface of the upper and lower polarizing plates 200 and 300 or any one surface of the liquid crystal cell 10. In one embodiment, the optical compensation layer 500 is adhered to the surface of the upper polarizing plate or the lower polarizing plate facing to one side of the liquid crystal cell. In another embodiment, as illustrated in FIG. 4, the optical compensation layer 500 directly adhered to a polarizer to attain a thin film structure, instead of the protective film of the upper and lower polarizing plates 200 and 300.

In another embodiment, as illustrated in FIG. 4, the polarization rotating layer is adhered to a surface of a polarizer of the upper polarizing plate or the lower polarizing plate facing to one side of the liquid crystal cell, and the optical compensation layer is adhered to the other surface of the liquid crystal cell on the polarizer in the upper polarizing plate or the lower polarizing plate. When the liquid crystal cell has the above mentioned structure, it is possible to attain a thin film structure, as well as high contrast ratios in a front side and slope.

Optionally, the liquid crystal cell of the present invention may further include an additional optical functioning layer. The optical functioning layer may include any one used for the liquid crystal panel in the related art, but not being particularly limited thereto. For example, the optical functioning layer may include an anti-reflective film, hard coating layer, low refractive index layer, high refractive index layer, antifouling layer, an antistatic layer, or the like, which may be used alone or in any combination of two or more thereof.

Liquid Crystal Display Device

The liquid crystal panel of the present invention may be as a component included in a liquid crystal display device. Other components of the liquid crystal display device and an assembling method thereof may employ any one known in the related art, and therefore, the liquid crystal display device of the present invention may be manufactured by a technique known in the related art, except that the above-described liquid crystal panel of the present invention is used, without particular limitation thereof.

Hereinafter, some embodiments are proposed to more concretely describe the present invention. However, the following examples are only given for illustrating the present invention and those skilled in the art will understand that various alterations and modifications are possible within the scope and spirit of the present invention. Such alterations and modifications may be duly within the scope of the appended claims.

### EXAMPLES

### Examples 1 to 6 and Comparative Example 1

VA mode liquid crystal panels having optical characteristics shown in Table 1 below were prepared in Examples 1 to 6 and Comparative Example 1, respectively. The polarization rotating layer was formed in a single layer structure in Example 1 and Comparative Example 1, respectively, and was formed in a three-layer structure in Examples 2 to 6. In addition, the liquid crystal panel of Example 6 was not provided with the retardation film (i.e., the optical compensation layer).

TABLE 1

| | Optical | | Comparative | | | | | | |
|---|---|---|---|---|---|---|---|---|---|
| | characteristics | | Example 1 | Example 1 | Example 2 | Example 3 | Example 4 | Example 5 | Example 6 |
| Upper | Absorption axis | | 0° | 0° | 0° | 0° | 0° | 0° | 0° |
| polarizing | | | | | | | | | |
| plate | | | | | | | | | |
| Retardation | Ro | | 60 | 60 | 60 | 60 | 60 | 60 | — |
| film | Nz | | 6.5 | 6.5 | 6.5 | 6.5 | 6.5 | 6.5 | — |
| | Slow axis | | 90° | 90° | 90° | 90° | 90° | 90° | — |
| Liquid crystal cell | | | VA | VA | VA | VA | VA | VA | VA |
| | | | Mode | Mode | Mode | Mode | Mode | Mode | Mode |
| Polarization | λ/2 | Ro | 1.0 | 0.88 | 1.0 | 0.88 | 1.06 | 1.0 | 0.88 |
| rotating | film | (450)/Ro | | | | | | | |
| layer | (1) | (550) | | | | | | | |
| | | Ro | 1.0 | 1.04 | 1.0 | 1.04 | 0.97 | 1.0 | 1.04 |
| | | (650)/Ro | | | | | | | |
| | | (550) | | | | | | | |
| | | Slow axis | 45° | 45° | 79° | 79° | 80° | −22.5° | 79° |
| | λ/2 | Ro | — | — | 1.0 | 0.88 | 1.0 | 1.0 | 0.88 |
| | film | (450)/Ro | | | | | | | |
| | (2) | (550) | | | | | | | |
| | | Ro | — | — | 1.0 | 1.04 | 1.0 | 1.0 | 1.04 |
| | | (650)/Ro | | | | | | | |
| | | (550) | | | | | | | |
| | | Slow axis | — | — | 45° | 45° | 45° | 45° | 45° |
| | λ/2 | Ro | — | — | 1.0 | 0.88 | 1.06 | 1.0 | 0.88 |
| | film | (450)/Ro | | | | | | | |
| | (3) | (550) | | | | | | | |
| | | Ro | — | — | 1.0 | 1.04 | 0.97 | 1.0 | 1.04 |
| | | (650)/Ro | | | | | | | |
| | | (550) | | | | | | | |
| | | Slow axis | — | — | 11° | 11° | 10° | 22.5° | 11° |
| | Overall | Ro | 1.0 | 0.88 | 0.84 | 0.78 | 0.85 | 0.85 | 0.78 |
| | characteristic | (450)/Ro | | | | | | | |
| | | (550) | | | | | | | |
| | | Ro | 1.0 | 1.04 | 1.06 | 1.05 | 1.04 | 1.05 | 1.05 |
| | | (650)/Ro | | | | | | | |
| | | (550) | | | | | | | |
| | | Slow axis | 45° | 45° | 45° | 45° | 45° | 45° | 45° |

| | | | | | | | | |
|---|---|---|---|---|---|---|---|---|
| Lower | Absorption axis | 0° | 0° | 0° | 0° | 0° | 0° | 0° |
| polarizing | | | | | | | | |
| plate | | | | | | | | |

### Experimental Example 1

### Contrast Ratio of Examples 1 to 6 and Comparative Example 1

In order to determine black luminance in a front side and slope of the liquid crystal panel configured as shown in Table 1, the transmittance was calculated by “TechWiz 1D”. (Sanayi System Co., Ltd.) Then, in a vertical polarizer configured to have a BLU brightness of 4500 cd/m² and include a liquid crystal (LC) panel, the black luminance in a front side was measured using a liquid crystal display device having a front CR of 5000:1, when an angle between the polarizers is 85 to 95°. Next, the measured values were corrected by comparing the same with the calculated values so as to obtain the black luminance in a front side and slope as shown in Table 2 below. Herein, CR was obtained by dividing the white luminance by the black luminance. Accordingly, in the same white luminance, the smaller the black luminance the more the CR is improved. In the present disclosure, the front side is the normal direction of the liquid crystal panel, and the luminance in a slope represents the maximum luminance in all directions where a difference between the front side and the viewing angle (i.e., facing angle) is 60° (Φ=60)°.

TABLE 2

| | Black luminance in | Black luminance in |
|---|---|---|
| | a front side | a slope |
| Comparative Example 1 | 7.8 | 12 |
| Example 1 | 2.9 | 5.2 |
| Example 2 | 0.111 | 4.7 |
| Example 3 | 0.095 | 4.8 |
| Example 4 | 0.21 | 5.2 |
| Example 5 | 0.41 | 5.2 |
| Example 6 | 0.095 | 14 |

According to Table 2, it can be seen that Examples of the present invention having the polarization rotating layer had remarkably excellent black luminance in a front side and slope, as compared with the Comparative Example 1. In addition, when the polarization rotating layer was formed in a three-layer structure, pronounced black luminance values were shown, and when the half wave plate formed in a three-layer structure had reverse wavelength dispersion characteristics or flat wavelength dispersion characteristics, further pronounced black luminance values were shown.

Further, by comparing Example 6 and Example 3, it can be seen that Example 3 further including the optical compensation layer had more improved black luminance in a slope, while the black luminance in a front side was not changed, as compared with Example 6.

### Experimental Example 2

### Evaluation of Optical Compensation Layer

Black luminance in a slope was calculated in the same manner as in Experimental Example 1, while varying the front retardation values and the refractive index ratios of the optical compensation layer applied to Example 2, and the results thereof are shown in Table 3 below.

TABLE 3

| | | Black luminance in |
|---|---|---|
| Ro | Nz | a slope |
| 30 | 10 | 12 |
| 40 | 8 | 9.7 |
| (Nz: 7.3~11.9) | 10 | 5.2 |
| | 11 | 9.4 |
| 60 | 5.6 | 8.7 |
| (Nz: 5.1~8.7) | 6.5 | 4.7 |
| | 7.5 | 9.6 |
| 80 | 3.8 | 8.9 |
| (Nz: 2.9~5.5) | 4.3 | 6.7 |
| | 5.1 | 9.1 |
| 100 | 3.5 | 11.9 |

According to Table 3, when using the optical compensation layer, the cases wherein having the front retardation values and the refractive index ratios of the present invention have more pronounced black luminance in a slope.

### Examples 7 to 12 and Comparative Example 2

IPS mode liquid crystal panels having optical characteristics shown in Table 4 below were prepared in Examples 7 to 12 and Comparative Example 2, respectively. The polarization rotating layer was formed in a single layer structure in Example 7 and Comparative Example 2, respectively, and was formed in a three-layer structure in Examples 8 to 12.

TABLE 4

| | Optical | | Comparative | | | | Example | Example | Example |
|---|---|---|---|---|---|---|---|---|---|
| | characteristics | | Example 2 | Example 7 | Example 8 | Example 9 | 10 | 11 | 12 |
| Upper | Absorption axis | | 0° | 0° | 0° | 0° | 0° | 0° | 0° |
| polarizing | | | | | | | | | |
| plate | | | | | | | | | |
| Retardation | Ro | | — | — | — | — | — | — | 150 |
| film | Nz | | — | — | — | — | — | — | 1.0 |
| | Slow axis | | — | — | — | — | — | — | 90° |
| Liquid crystal cell | | | IPS | IPS | IPS | IPS | IPS | IPS | IPS |
| | | | Mode | Mode | Mode | Mode | Mode | Mode | Mode |
| Polarization | λ/2 | Ro | 1.0 | 0.88 | 1.0 | 0.88 | 1.06 | 1.0 | 1.0 |
| rotating | film | (450)/Ro | | | | | | | |
| layer | (1) | (550) | | | | | | | |
| | | Ro | 1.0 | 1.04 | 1.0 | 1.04 | 0.97 | 1.0 | 1.0 |
| | | (650)/Ro | | | | | | | |
| | | (550) | | | | | | | |
| | | Slow Axis | 45° | 45° | 79° | 79° | 80° | −22.5° | 79° |
| | λ/2 | Ro | | | 1.0 | 0.88 | 1.0 | 1.0 | 1.0 |
| | film | (450)/Ro | | | | | | | |
| | (2) | (550) | | | | | | | |
| | | Ro | | | 1.0 | 1.04 | 1.0 | 1.0 | 1.0 |
| | | (650)/Ro | | | | | | | |
| | | (550) | | | | | | | |
| | | Slow Axis | | | 45° | 45° | 45° | 45° | 45° |
| | λ/2 | Ro | | | 1.0 | 0.88 | 1.06 | 1.0 | 1.0 |
| | film | (450)/Ro | | | | | | | |
| | (3) | (550) | | | | | | | |
| | | Ro | | | 1.0 | 1.04 | 0.97 | 1.0 | 1.0 |
| | | (650)/Ro | | | | | | | |
| | | (550) | | | | | | | |
| | | Slow Axis | | | 11° | 11° | 10° | 22.5° | 11° |
| | Overall | Ro | 1.0 | 0.88 | 0.84 | 0.78 | 0.85 | 0.85 | 0.84 |
| | characteristic | (450)/Ro | | | | | | | |
| | | (550) | | | | | | | |
| | | Ro | 1.0 | 1.04 | 1.06 | 1.05 | 1.04 | 1.05 | 1.06 |
| | | (650)/Ro | | | | | | | |
| | | (550) | | | | | | | |
| | | Slow Axis | 45° | 45° | 45° | 45° | 45° | 45° | 45° |

| | | | | | | | | |
|---|---|---|---|---|---|---|---|---|
| Lower | Absorption axis | 0° | 0° | 0° | 0° | 0° | 0° | 0° |
| polarizing | | | | | | | | |
| plate | | | | | | | | |

### Experimental Example 3

### Contrast Ratio of Examples 7 to 12 and Comparative Example 2

Black luminance in a front side and slope of the liquid crystal panels prepared according to Table 4 was calculated in the same manner as in Experimental Example 1, and the results thereof are shown in Table 5 below.

TABLE 5

| | Black luminance in a front side |
|---|---|
| Comparative Example 2 | 8.2 |
| Example 7 | 3.1 |
| Example 8 | 0.123 |
| Example 9 | 0.098 |
| Example 10 | 0.36 |
| Example 11 | 0.78 |
| Example 12 | 0.123 |

According to Table 5, it can be seen that the Examples of the present invention having the polarization rotating layer had remarkably excellent black luminance in a front side, as compared with Comparative Example 2. In addition, when the polarization rotating layer was formed in a three-layer structure, pronounced black luminance values were shown, and when the half wave plate formed in a three-layer structure had reverse wavelength dispersion characteristics or flat wavelength dispersion characteristics, further pronounced black luminance values were shown.

### Experimental Example 4

### Evaluation of Optical Compensation Layer

Black luminance in a slope was calculated in the same manner as in Experimental Example 1, while varying the front retardation values and the refractive index ratios of the optical compensation layer applied to Example 12, and the results thereof are shown in Table 6 below.

TABLE 6

| | | Black luminance in a |
|---|---|---|
| Ro | Nz | slope |
| 30 | 1.0 | 13.9 |
| 100 | 1.0 | 9.1 |
| | 1.1 | 9.2 |
| 150 | 1.0 | 5.8 |
| | 1.1 | 7.1 |
| 220 | 1.0 | 9.2 |
| | 1.1 | 10.8 |
| 300 | 1.0 | 13.1 |

According to Table 6, it can be seen that, when using the optical compensation layer, the cases of having the front retardation values and the refractive index ratios of the present invention have more improved black luminance in a slope.

What is claimed is:

1. A liquid crystal panel, comprising:
an upper polarizing plate and a lower polarizing plate whose absorption axes are disposed to be parallel to each other;
a liquid crystal cell disposed between the upper polarizing plate and the lower polarizing plate; and
a polarization rotating layer disposed between the upper polarizing plate and the lower polarizing plate to rotate linearly polarized light by 85° to 95°, the polarization rotating layer having reverse wavelength dispersion characteristics.

2. The liquid crystal panel according to claim 1, wherein the polarization rotating layer has wavelength dispersion characteristics of Ro (450)/Ro (550)=0.75 to 0.95 and Ro (650)/Ro (550)=1.0 to 1.1.

3. The liquid crystal panel according to claim 1, wherein the polarization rotating layer includes a single half (½) wave plate layer or a plurality of half (½) wave plate layers.

4. The liquid crystal panel according to claim 1, wherein the polarization rotating layer includes three half (½) wave plate layers, and each of the half wave plates has an angle between an optical axis thereof and the absorption axis of the polarizing plate in a range of 6° to 16°, 40° to 50°, and 74° to 84°.

5. The liquid crystal panel according to claim 1, wherein the polarization rotating layer includes three half (½) wave plate layers, and each of the half wave plates has an angle between an optical axis thereof and the absorption axis of the polarizing plate in a range of 8° to 14°, 42° to 48°, and 76° to 82°.

6. The liquid crystal panel according to claim 1, wherein the polarization rotating layer includes three half (½) wave plate layers, and each of the half wave plates has an angle between an optical axis thereof and the absorption axis of the polarizing plate in a range of 17.5° to 27.5°, 40° to 50°, and −27.5° to −17.5°.

7. The liquid crystal panel according to claim 3, wherein the polarization rotating layer is formed in a plurality of half (½) wave plate layers, and any one of the plurality half wave plate layers has wavelength dispersion characteristics of Ro (450)/Ro (550)=1.0 to 1.1, and Ro (650)/Ro (550)=0.9 to 1.0.

8. The liquid crystal panel according to claim 1, wherein the polarization rotating layer is adhered to a surface of the upper polarizing plate or the lower polarizing plate facing to one side of the liquid crystal cell.

9. The liquid crystal panel according to claim 1, wherein the polarization rotating layer is adhered to a surface of a polarizer of the upper polarizing plate or the lower polarizing plate facing to one side of the liquid crystal cell.

10. The liquid crystal panel according to claim 1, further comprising an optical compensation layer.

11. The liquid crystal panel according to claim 1, wherein the liquid crystal cell has a vertical alignment liquid crystal mode or a horizontal alignment liquid crystal mode.

12. The liquid crystal panel according to claim 11, wherein, when the liquid crystal cell has a vertical alignment liquid crystal mode, the liquid crystal cell further comprises an optical compensation layer having retardation characteristics of front retardation value in a range of Ro 40 to 90 nm, and refractive index ratio Nz in a range of −0.11×Ro+11.7 to −0.16×Ro+18.3.

13. The liquid crystal panel according to claim 11, wherein, when the liquid crystal cell has a horizontal alignment liquid crystal mode, the liquid crystal cell further comprises an optical compensation layer having retardation characteristics of front retardation value in a range of Ro 70 to 270 nm, and refractive index ratio (Nz) in a range of 0.9 to 1.3.

14. The liquid crystal panel according to claim 12, wherein the optical compensation layer is adhered to the surface of the upper polarizing plate or the lower polarizing plate facing to one side of the liquid crystal cell.

15. The liquid crystal panel according to claim 12, wherein the optical compensation layer is adhered to the surface of the polarizer of the upper polarizing plate or the lower polarizing plate facing to one side of the liquid crystal cell.

16. The liquid crystal panel according to claim 12, wherein the polarization rotating layer is adhered to the surface of the polarizer of the upper polarizing plate or the lower polarizing plate facing to one side of the liquid crystal cell, and the optical compensation layer is adhered to the surface of the polarizer of the upper polarizing plate or the lower polarizing plate facing to the other side of the liquid crystal cell.

17. The liquid crystal panel according to claim 13, wherein the optical compensation layer is adhered to the surface of the upper polarizing plate or the lower polarizing plate facing to one side of the liquid crystal cell.

18. The liquid crystal panel according to claim 13, wherein the optical compensation layer is adhered to the surface of the polarizer of the upper polarizing plate or the lower polarizing plate facing to one side of the liquid crystal cell.

19. The liquid crystal panel according to claim 13, wherein the polarization rotating layer is adhered to the surface of the polarizer of the upper polarizing plate or the lower polarizing plate facing to one side of the liquid crystal cell, and the optical compensation layer is adhered to the surface of the polarizer of the upper polarizing plate or the lower polarizing plate facing to the other side of the liquid crystal cell.

20. A liquid crystal display device comprising the liquid crystal panel according to claim 1.
